(19) United States
(12) Patent Application Publication
(10) Pub. No.: US 2007/0008565 A1
(43) Pub. Date: Jan. 11, 2007

(54) PRINTING APPARATUS

(75) Inventor: Hajime ASANO, Fukuoka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/456,244

(22) Filed: Jul. 10, 2006

(30) Foreign Application Priority Data
Jul. 11, 2005 (JP) 2005/201521

(51) Int. Cl. G06K 15/00

(52) U.S. Cl. 358/1.12

(57) ABSTRACT

A printing apparatus has a memory 5 that stores image data for overprinting making it difficult to notice characters printed by overprinting, an image rendering unit 7 that renders image data on the basis of a rendering command of the memory and expands the image data for overprinting, and a printer engine unit 8 that prints and records the image data transmitted from the image rendering unit 7 on a paper. The printer engine unit 8 overprints the image data for overprinting on the printed paper.

### BACKGROUND OF THE INVENTION

The present invention relates to a printing apparatus, such as a printer or a compound machine having a printer.

In order to dispose confidential documents, on which important information, such as confidential affairs, is described, a shredder is provided in an office, and the confidential documents are shredded by the shredder.

A shredder is detachably mounted on a printer or a compound machine having a printer in order to shred the confidential documents (for example, see Patent Document 1). [Patent Document 1] JP-A-6-63435

For this reason, a separate space for installing a shredder, in addition to a printing apparatus, such as a printer or the like, is required in a limited environmental space of an office or the like.

### SUMMARY OF THE INVENTION

Accordingly, it is an object of the invention to provide a printing apparatus that can dispose confidential documents, without needing a shredder.

According to an aspect of the invention, a printing apparatus includes a paper feed port that sets a recording medium (hereinafter, referred to as “paper”, such as an OHP sheet and so on), on which an image is printed, a data holding unit that stores predetermined image data for overprinting, an operating unit that instructs overprinting on the recording medium, and an image recording unit that overprints the predetermined image data for overprinting on the recording medium set in the paper feed port by the instruction of the operating unit. The predetermined image data for overprinting has complexity according to predetermined ununiformity.

The predetermined image data for overprinting may have complexity according to the predetermined uniformity by an image pattern having a plurality of spatial frequency components in a predetermined direction.

The plurality of spatial frequency components may be generated by an arrangement of a random character group.

According to the aspects of the invention, the image data for overprinting is overprinted on the printed paper, such as a confidential document or the like, by the printing apparatus, such that the described content can be noticed. Accordingly, it is possible to dispose the confidential document, without needing a separate shredder.

Therefore, a space for installing a shredder in an office or the like does not need to be secured, and thus a limited environmental space can be effectively used.

### BRIEF DESCRIPTION OF THE DRAWINGS

FIG. 1 is a block diagram showing the configuration of a printing apparatus according to a first embodiment of the invention.

FIG. 2 is a flowchart showing a procedure of a printing operation that is performed in the printing apparatus of FIG. 1.

FIG. 3 is a diagram showing an example of image data for overprinting in the printing apparatus of FIG. 1.

FIG. 4 is a diagram showing another example of image data for overprinting in the printing apparatus of FIG. 1.

FIG. 5 is a block diagram showing the configuration of a printing apparatus according to a second embodiment of the invention.

FIG. 6 is a flowchart showing a procedure of a printing operation that is performed in the printing apparatus of FIG. 5.

FIG. 7 is a block diagram showing the configuration of a printing apparatus according to a third embodiment of the invention.

FIG. 8 is a flowchart showing a procedure of a printing operation that is performed in the printing apparatus of FIG. 7.

FIG. 9 is a block diagram showing an example of the configuration of a printer engine unit in the printing apparatus of FIG. 7.

FIG. 10 is a flowchart showing a procedure of a printing operation in the printer engine unit of FIG. 9.

FIG. 11 is a block diagram showing the configuration of a printing apparatus according to a fourth embodiment of the invention.

FIG. 12 is a flowchart showing a procedure of a printing operation that is performed in the printing apparatus of FIG. 11.

FIG. 13 is a block diagram showing an example of the configuration of a printer engine unit in the printing apparatus of FIG. 11.

FIG. 14 is a flowchart showing a procedure of a printing operation in the printer engine unit of FIG. 13.

### DETAILED DESCRIPTION OF THE PREFERRED EMBODIMENTS

Hereinafter, embodiments of the invention will be specifically described with reference to the drawings. In the accompanying drawings, the same parts are represented by the same reference numerals, and the descriptions thereof will be omitted. Moreover, the descriptions are given for the embodiments for carrying out the invention, and thus the invention is not limited to the embodiments.

### First Embodiment

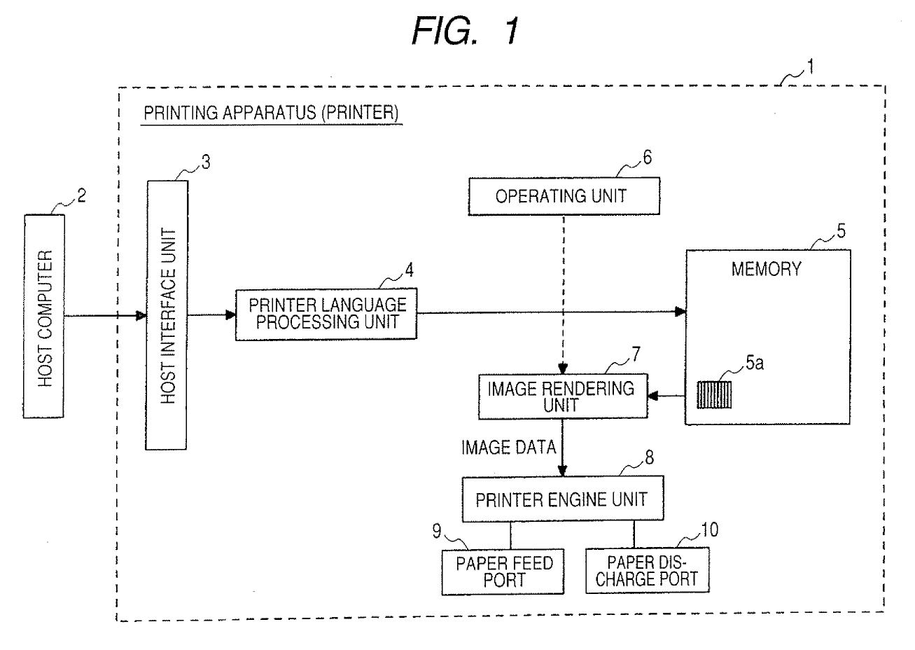

FIG. 1 is a block diagram showing the configuration of a printing apparatus according to a first embodiment of the invention.

Here, a printer that reads a printer language, such as a page description language or the like, to be transmitted from a host computer 2 connected to the outside, and prints and outputs the read printer language is exemplified as an example of a printing apparatus according to an embodiment of the invention,

In FIG. 1, a printing apparatus 1 primarily includes a host interface unit 3 that receives a printer language to be transmitted from the external host computer 2, a printer language processing unit 4 that analyzes the printer language received by the host interface unit 3, converts the printer language into a rendering command, and writes the rendering command into a memory (data holding unit) 5, an image rendering unit 7 that renders image data on the basis of the rendering command in the memory 5 or expands image data 5a for overprinting in the memory 5 (image data that is overprinted on a previously printed paper and makes it difficult to notice characters) to a required size, a printer engine unit (image recording unit) 8 that prints and records the image data to be transmitted from the image rendering unit 7 on a paper, accompanied by a paper feed port 9, through which a paper to be printed is supplied, and a paper discharge port 10, through which a printed paper is discharged, and an operating unit 6 that allows an operator (user) to perform a required operation. Then, the overall operation of the printing apparatus 1 is controlled by a control unit (not shown).

In this embodiment, in the memory 5 that stores the rendering command, normal image data and image data for overprinting are stored together, but the normal image data and the image data for overprinting may be stored in different memories. The same is applied to other embodiments.

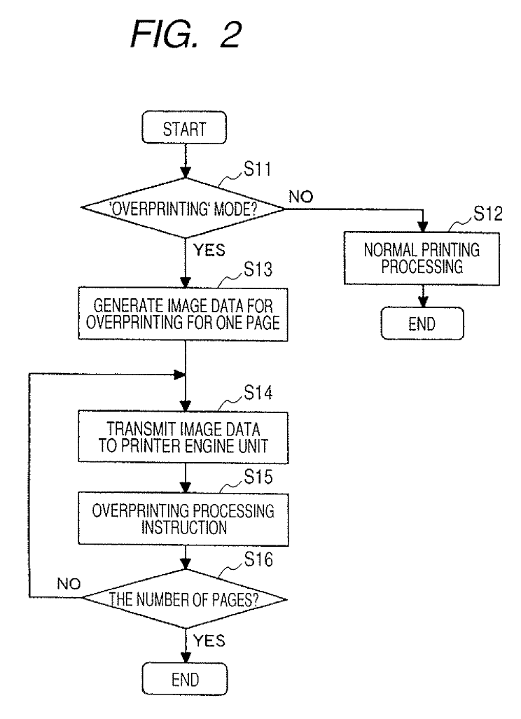

FIG. 2 is a flowchart showing a procedure of a printing operation that is performed in the printing apparatus of FIG. 1.

The printing operation that is performed in the above-described printing apparatus will now be described in detail with reference to FIG. 2.

First, it is judged whether or not the operator selects an overprinting mode in the operating unit 6 (Step S11).

At Step S11, when it is judged that the overprinting mode is not selected, a normal printing processing is performed (Step S12) That is, the image rendering unit 7 acquires the rendering command (not shown) in the memory 5 and performs rendering on the basis of the command. The rendering result is transmitted to the printer engine unit 8 as image data. Then, a paper in the paper feed port 9 is transferred to a printing and recording position in the printer engine unit 8, and the image data is printed and recorded on the paper. Next, the printed and recorded paper is discharged from the paper discharge port 10.

Meanwhile, at Step S11, when it is judged that the overprinting mode is selected, first, image data for overprinting for one page is generated (Step S13). That is, the image rendering unit 7 acquires the image data 5a for overprinting in the memory 5, and generates the image data for overprinting for one page.

Next, the image data is transmitted to the printer engine unit 8 (Step S14). That is, a printed paper, such as a confidential document or the like, set in the paper feed port 9 by the operator in advance is transferred to the printing and recording position in the printer engine unit 8, and an overprinting processing for overprinting and recording the image data for overprinting is instructed (Step S15). Next, the overprinted paper is discharged from the paper discharge port 10.

Steps S11 to S15 form an overprinting processing for one page. Then, it is judged whether or not the number of processed pages reaches the number of pages set in the operating unit 6 by the operator (Step S16). That is, the overprinting processing is performed according to the required number of pages.

As described above, according to the printing apparatus of the first embodiment, the image data for overprinting is overprinted on the printed paper, such as the confidential document or the like, by the printing apparatus, such that a printed content cannot be noticed. Therefore, it is possible to dispose the confidential document and so on, without needing a separate shredder

As for the image data 5a for overprinting used in the printing apparatus, any image data can be used as long as it is overprinted on the printed paper and makes it difficult to notice previously printed characters. The image data 5a for overprinting may be rectangular image data, that is, image data that is printed to fill one entire surface of the printed paper, such as the confidential document or the like.

The image data 5a for overprinting used in the printing apparatus may be character image data, that is, image data, by which a character group is overprinted on one entire surface of the printed paper. Accordingly, character information described in the printed paper, such as the confidential document or the like, is rarely noticed.

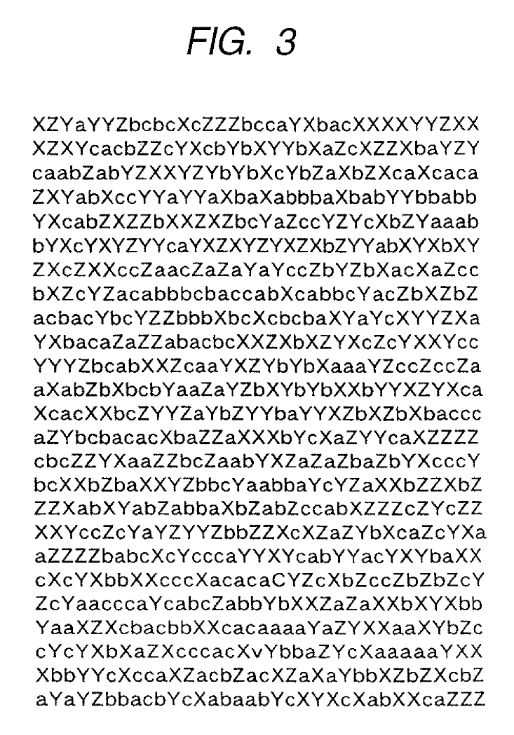

FIG. 3 shows an example where character image data is printed on a blank paper. In this case, segments of lines and curves of each character have various angles. Accordingly, when the character image data is overprinted, the character information described in a background paper is rarely noticed.

As shown in FIG. 3, in this embodiment, a random character group is used as image data for overprinting.

The character image data may have a character group having a plurality of character sizes. Accordingly, a degree of coincidence of the sizes of the overprinted characters and the characters described in the background paper to be overprinted is likely to be increased. Therefore, the character information described in the printed paper, such as the confidential document or the like, is rarely noticed.

The character image data may have a character group having a plurality of character angles. Accordingly, a degree of coincidence of the sizes of the overprinted characters and the characters described in the background paper to be overprinted is likely to be increased. Therefore, the character information described in the printed paper, such as the confidential document or the like, is rarely noticed.

The character image data may have a character group having a plurality of character sizes and a plurality of character angles. Accordingly, by a multiplier effect of the character sizes and the character angles, the character information described in the printed paper, such as the confidential document or the like, is rarely noticed.

The character image data may have a significant character string, that is, a character string through which the meaning of a document can be recognized.

Accordingly, since a degree of derangement of overprinted character information and character information described in the background paper to be overprinted is likely to be increased, the character information described in the printed paper, such as the confidential document or the like, is rarely noticed. The significant character string may use at least one of a plurality of character sizes and a plurality of character angles. Accordingly, the character information described in the printed paper, such as the confidential document or the like, is further rarely noticed.

The image data 5a for overprinting used in the printing apparatus may be line drawing image data, that is, image data, by which a ling drawing group is overprinted on one entire surface of the printed paper, such as the confidential document or the like. Accordingly, table information, drawing information, character information, and so on described in the printed paper, such as the confidential document or the like, is further rarely noticed.

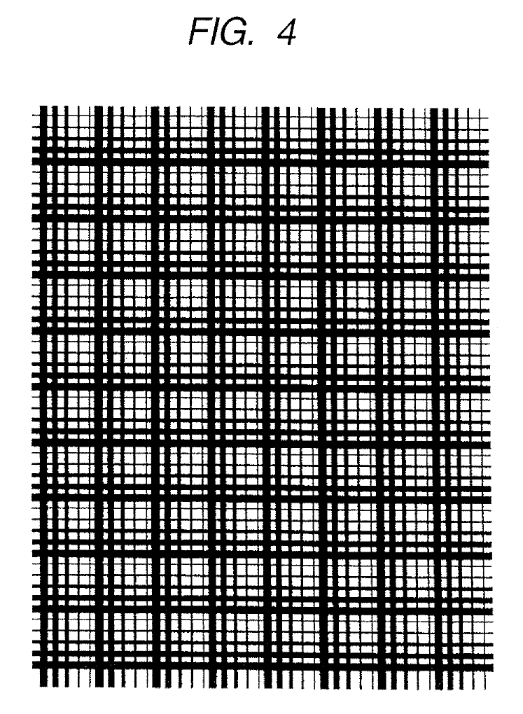

FIG. 4 shows an example of the line drawing image data. In FIG. 4, a lattice pattern is printed on a blank paper, and the lattice obtained by combining lines having various boldnesses makes it difficult to notice the table information, the drawing information, and the character information described in the background paper to be overprinted.

The line drawing image data is not limited to a line, but may also use a dotted line, a circle, or the like. In FIG. 4, the lines of the lattice cross each other at 90 degrees, but the lines may cross each other at a certain angle.

The line drawing image data may be used, together with various kinds of above-described character image data. Accordingly, table information, drawing information, character information, and so on described in the printed paper, such as the confidential document or the like, is further rarely noticed.

As such, the pattern for overprinting used in the first embodiment has complexity according to predetermined ununiformity. The complexity according to the ununiformity is secured by using a pattern having a plurality of spatial frequency components in a predetermined direction (for example, a horizontal direction or a vertical direction in the drawing), like a character pattern of FIG. 3 or a line drawing pattern of FIG. 4).

According to the experiments performed by the inventors, even though overprinting is uniformly performed on the paper recorded wit the image using patterns having a uniform density or uniform arrangement, when the paper is held up against a light, the character information that should be concealed by overprinting can be often noticed. However, in this embodiment, as described in detail above, since a character pattern or a pattern having a plurality of boldnesses (that is, a pattern having complexity according to the predetermined ununiformity) is overprinted, the information (in particular, significant information, such as characters and so on) that is recorded on the paper in advance can be almost completely concealed.

This is because an image behind an image having a complex arrangement pattern is rarely noticed due to a visual characteristic by a so-called mask effect.

The above-described pattern for overprinting is preferably formed at a density as high as possible. For example, when the above-described printing apparatus can reproduce multiple gray-scale levels, the pattern for overprinting may be formed on the basis of image data having the maximum density.

With this configuration, a density contrast of a portion where the pattern is disposed and a portion where the pattern is not disposed is increased, and thus the so-called mask effect can be effectively used.

In a printing apparatus that uses only binary image data, not having selections other than ON/OFF, an image forming process of the printing apparatus may be controlled at a high density. This corresponds to a control for increasing an absolute value of a development bias in a known electrophotographic system.

### Second Embodiment

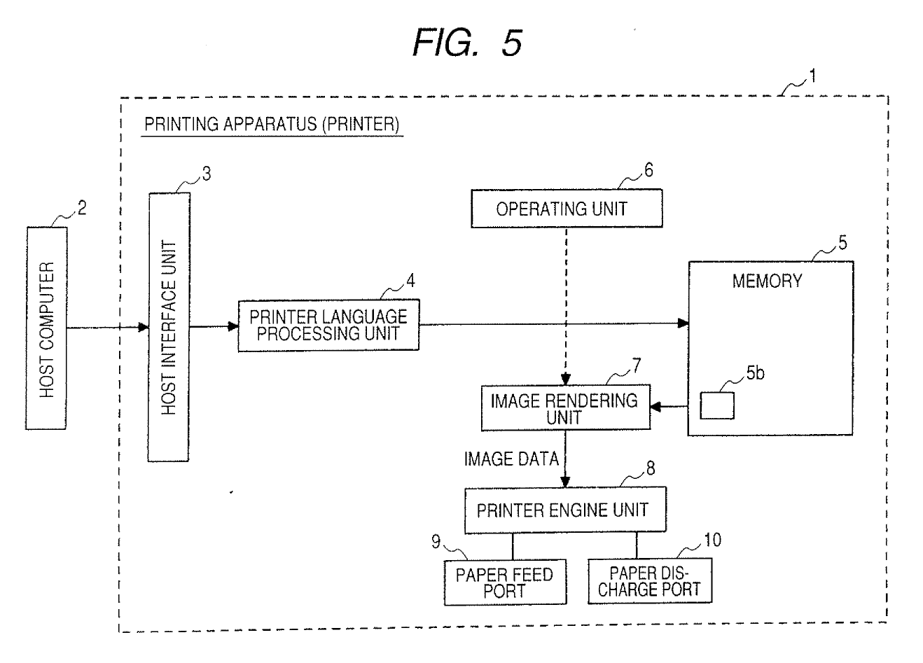

FIG. 5 is a block diagram showing the configuration of a printing apparatus according to a second embodiment of the invention.

Here, a printer that reads a printer language, such as a page description language or the like, to be transmitted from a host computer 2 connected to the outside, and prints and outputs the read printer language is exemplified as an example of a printing apparatus according to an embodiment of the invention.

In FIG. 5, the image data 5a for overprinting in the memory 5 of the configuration shown in FIG. 1 according to the first embodiment is substituted with rendering command 5b for overprinting.

In FIG. 5, a printing apparatus 1 primarily includes a host interface unit 3 that receives a printer language to be transmitted from the external host computer 2, a printer language processing unit 4 that analyzes the printer language received by the host interface unit 3, converts the printer language into a rendering command, and writes the rendering command into a memory (data holding unit) 5, an image rendering unit 7 that renders image data on the basis of the rendering command in the memory 5 or renders rendering command 5b for overprinting in the memory 5 (rendering command that is overprinted on a previously printed paper and makes it difficult to notice characters), a printer engine unit (image recording unit) 8 that prints and records the image data to be transmitted from the image rendering unit 7 on a paper, accompanied by a paper feed port 9, through which a paper to be printed is supplied, and a paper discharge port 10, through which a printed paper is discharged, and an operating unit 6 that allows an operator (user) to perform a required operation. Then, the overall operation of the printing apparatus 1 is controlled by a control unit (not shown).

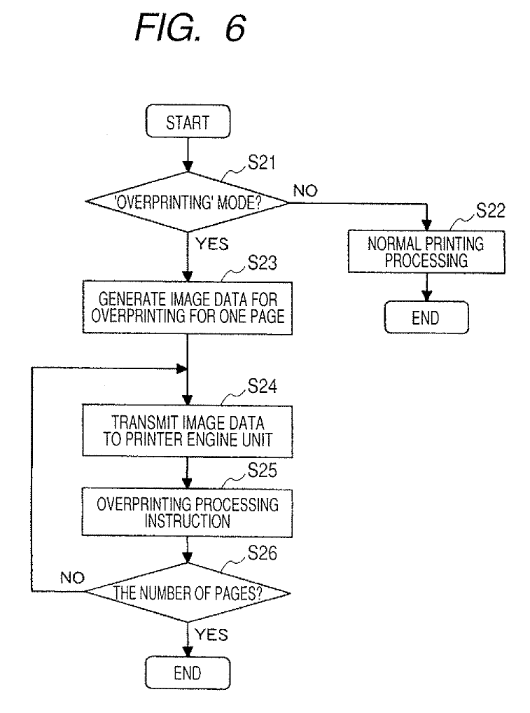

FIG. 6 is a flowchart showing a procedure of a printing operation that is performed in the printing apparatus of FIG. 5.

The printing operation that is performed in the above-described printing apparatus will now be described in detail with reference to FIG. 6.

First, it is judged whether or not the operator selects an overprinting mode in the operating unit 6 (Step S21).

At Step S21, when it is judged that the overprinting mode is not selected, a normal printing processing is performed (Step S22). That is, the image rendering unit 7 acquires the rendering command (not shown) in the memory 5 and performs rendering on the basis of the command. The rendering result is transmitted to the printer engine unit 8 as image data. Then, a paper in the paper feed port 9 is transferred to a printing and recording position in the printer engine unit 8, and the image data is printed and recorded on the paper. Next, the printed and recorded paper is discharged from the paper discharge port 10.

Meanwhile, at Step S21, when it is judged that the overprinting mode is selected, first, image data for overprinting for one page is generated (Step S23). That is, the image rendering unit 7 acquires the rendering command 5b for overprinting in the memory 5, and generates the image data for overprinting for one page on the basis of the rendering command.

Next, the image data is transmitted to the printer engine unit 8 (Step S24). That is, a printed paper, such as a confidential document or the like, set in the paper feed port 9 by the operator in advance is transferred to the printing and recording position in the printer engine unit 8, and an overprinting processing for overprinting and recording the image data for overprinting is instructed (Step S25). Next, the overprinted paper is discharged from the paper discharge port 10.

Steps S21 to S25 form an overprinting processing for one page. Then, it is judged whether or not the number of processed pages reaches the number of pages set in the operating unit 6 by the operator (Step S26). That is, the overprinting processing is performed according to the required number of pages.

As described above, according to the printing apparatus of the second embodiment, the image data for overprinting is overprinted on the printed paper, such as the confidential document or the like, by the printing apparatus, such that a printed content cannot be noticed. Therefore, it is possible to dispose the confidential document and so on, without needing a separate shredder.

As for the rendering command 5b for overprinting used in the printing apparatus, any image data can be used as long as it is overprinted on the printed paper and makes it difficult to notice previously printed characters. The rendering command 5b for overprinting may be a rectangular rendering command, that is, a rendering command that is printed to fill one entire surface of the printed paper, such as the confidential document or the like.

The rendering command 5b for overprinting used in the printing apparatus may be a character rendering command (for example, a character rendering command, by which character image data, as shown in FIG. 3 in the first embodiment, is rendered), that is, a rendering command, by which a character group is overprinted on the printed paper, such as the confidential document or the like. Accordingly, the character information described in the printed paper, such as the confidential document or the like, is rarely noticed.

The character rendering command may have a command group, by which a character group having a plurality of character sizes is rendered. Accordingly, a degree of coincidence of the sizes of the overprinted characters and the characters described in the background paper to be overprinted is likely to be increased. Therefore, the character information described in the printed paper, such as the confidential document or the like, is rarely noticed.

The character rendering command may have a command group, by which a character group having a plurality of character angles is rendered. Accordingly, a degree of coincidence of the sizes of the overprinted characters and the characters described in the background paper to be overprinted is likely to be increased. Therefore, the character information described in the printed paper, such as the confidential document or the like, is rarely noticed.

The character rendering command may have a command group, by which a character group having a plurality of character sizes and a plurality of character angles is rendered. Accordingly, by a multiplier effect of the character sizes and the character angles, the character information described in the printed paper, such as the confidential document or the like, is rarely noticed.

The character image data may have a command group, by which a significant character string is rendered. Accordingly, a degree of derangement of information of the overprinted characters and information of the characters described in the background paper to be overprinted is likely to be increased. Therefore, the character information described in the printed paper, such as the confidential document or the like, is rarely noticed. Moreover, the significant character string may be used together with at least one of the plurality of character sizes and the plurality of character angles. Therefore, the character information described in the printed paper, such as the confidential document or the like, is further rarely noticed.

The rendering command 5b for overprinting used in the printing apparatus may be a line drawing image command, that is, an image command (for example, a line drawing rendering command, by which line drawing image data, as shown in FIG. 4 in the first embodiment, is rendered), by which a ling drawing group is overprinted on one entire surface of the printed paper, such as the confidential document or the like. Accordingly, table information, drawing information, character information, and so on described in the printed paper, such as the confidential document or the like, is further rarely noticed.

The line drawing command may be used together with various character rendering commands. Accordingly, the table information, the drawing information, and character information described in the printed paper, such as the confidential document or the like, are rarely noticed.

As such, the pattern for overprinting according to the drawing command used in the second embodiment has the complexity according to the predetermined ununiformity. The complexity according to the ununiformity is secured by using a pattern having a plurality of spatial frequency components in a predetermined direction (for example, a horizontal direction or a vertical direction in the drawing), like the character pattern of FIG. 3 or the line drawing pattern of FIG. 4.

When the pattern for overprinting has the complexity according to the ununiformity, the reason why a concealment effect increases is as described in detail in the first embodiment, and the description thereof will be omitted.

### Third Embodiment

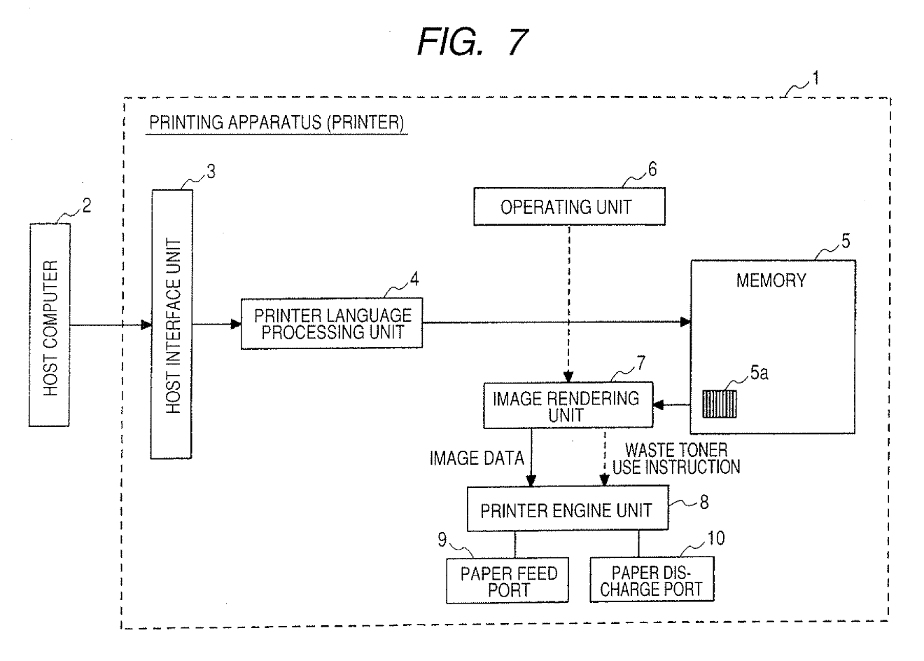

FIG. 7 is a block diagram showing the configuration of a printing apparatus according to a third embodiment of the invention.

Here, a printer that reads a printer language, such as a page description language or the like, to be transmitted from a host computer 2 connected to the outside, and prints and outputs the read printer language is exemplified as an example of a printing apparatus according to an embodiment of the invention.

In FIG. 7, a printing apparatus 1 primarily includes a host interface unit 3 that receives a printer language to be transmitted from the external host computer 2, a printer language processing unit 4 that analyzes the printer language received by the host interface unit 3, converts the printer language into a rendering command, and writes the rendering command into a memory (data holding unit) 5, an image rendering unit 7 that renders image data on the basis of the rendering command in the memory 5 or expands image data 5a for overprinting in the memory 5 (image data that is overprinted on a previously printed paper and makes it difficult to notice characters) to a required size, a printer engine unit (image recording unit) 8 that prints and records the image data to be transmitted from the image rendering unit 7 on a paper, accompanied by a paper feed port 9, through which a paper to be printed is supplied, and a paper discharge port 10, through which a printed paper is discharged, and an operating unit 6 that allows an operator (user) to perform a required operation. Then, the overall operation of the printing apparatus 1 is controlled by a control unit (not shown).

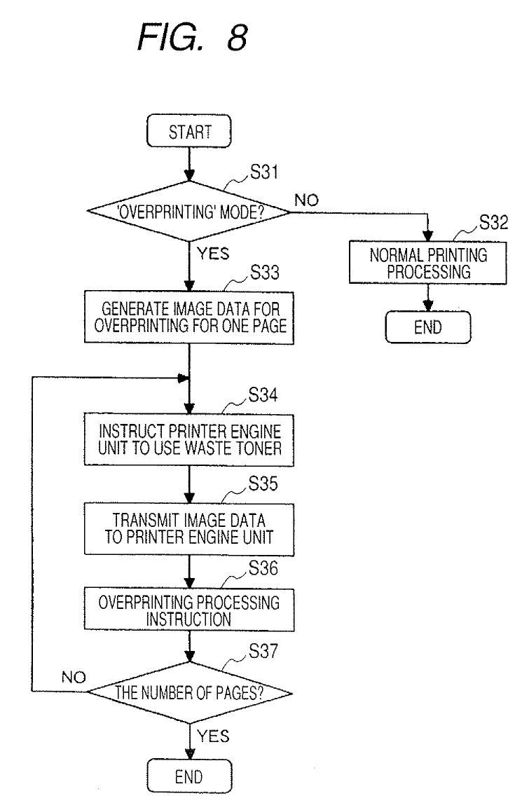

FIG. 8 is a flowchart showing a procedure of a printing operation that is performed in the printing apparatus of FIG. 7.

The printing operation that is performed in the above-described printing apparatus will now be described in detail with reference to FIG. 8.

First, it is judged whether or not the operator selects an overprinting mode in the operating unit 6 (Step S31).

At Step S31, when it is judged that the overprinting mode is not selected, a normal printing processing is performed (Step S32). That is, the image rendering unit 7 acquires the rendering command (not shown) in the memory 5 and performs rendering on the basis of the command. The rendering result is transmitted to the printer engine unit 8 as image data. Then, a paper in the paper feed port 9 is transferred to a printing and recording position in the printer engine unit 8, and the image data is printed and recorded on the paper. Next, the printed and recorded paper is discharged from the paper discharge port 10.

Meanwhile, at Step S31, when it is judged that the overprinting mode is selected, first, image data for overprinting for one page is generated (Step S33). That is, the image rendering unit 7 acquires the image data 5a for overprinting in the memory 5, and generates the image data for overprinting for one page.

Next, the printer engine unit 8 is instructed to use a waste toner (Step S34), and then the image data for overprinting is transmitted to the printer engine unit 8 (Step S35). That is, a printed paper, such as a confidential document or the like, set in the paper feed port 9 by the operator in advance is transferred to the printing and recording position in the printer engine unit 8, and an overprinting processing for overprinting and recording the image data for overprinting is instructed using the waste toner (Step S36). Next, the overprinted paper is discharged from the paper discharge port 10.

Steps S31 to S36 form an overprinting processing for one page. Then, it is judged whether or not the number of processed pages reaches the number of pages set in the operating unit 6 by the operator (Step S37). That is, the overprinting processing is performed according to the required number of pages.

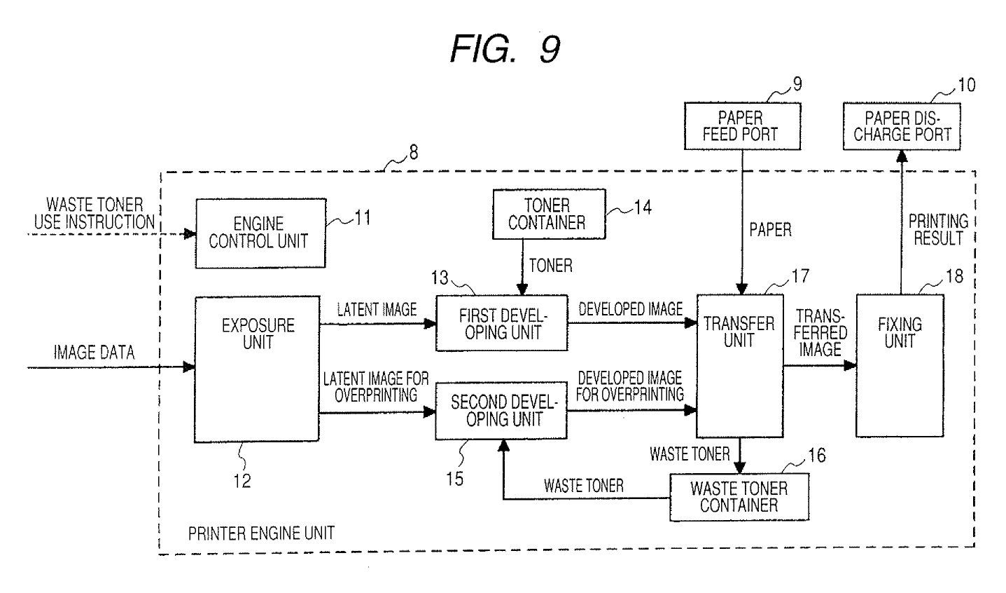

FIG. 9 is a block diagram showing an example of the configuration of a printer engine unit in the printing apparatus of FIG. 7.

In FIG. 9, the printer engine unit 8 primarily includes an engine control unit 11, an exposure unit 12 that receives image data from the outside of the printer engine unit 8, and performs an exposure on a charged photosensitive member (not shown) so as to form a latent image, a first developing unit 13 that develops the latent image using a toner stored in a toner container 14, a second developing unit 15 that develops the latent image using a waste toner stored in a waste toner container (waste toner storage unit) 16, a transfer unit 17 that transfers the developed image on a paper transferred from the paper feed port 9, and a fixing unit 18 that heats the image transferred on the paper so as to fix the image on the paper.

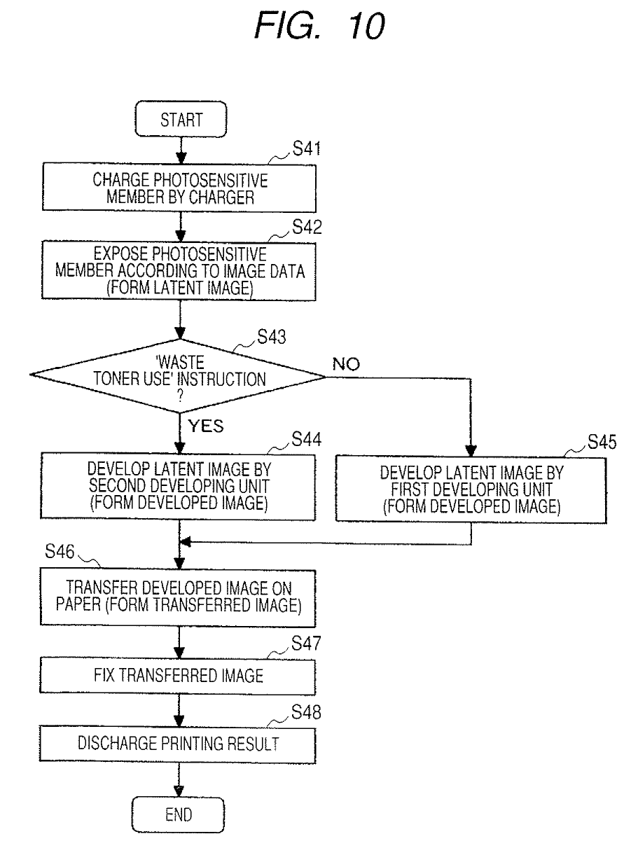

FIG. 10 is a flowchart showing a procedure of a printing operation in the printer engine unit of FIG. 9.

The printing operation in the printer engine unit 8 will be described in detail with reference to FIG. 10.

First, after the printer engine unit 8 starts, the photosensitive member (not shown) is charged by a charger (not shown) (Step S41).

Next, the exposure unit 12 performs the exposure on the charged photosensitive member according to the image data received from the image rendering unit 7 (Step S42). That is, since the normal printing operation is performed when the operator does not select the overprinting mode in the operating unit 6, the exposure is performed using the image data for normal printing to be transmitted from the image rendering unit 7, such that the latent image is formed on the photosensitive member. Meanwhile, when the operator selects the overprinting mode, the exposure is performed using the image data for overprinting to be transmitted from the image rendering unit 7, such that a latent image for overprinting is formed on the photosensitive member.

Next, it is judged in the engine control unit 11 whether or not a waster toner use instruction is output from the image rendering unit 7 (Step S43).

Next, at Step S43, when it is judged that the waste toner use instruction is not output, a normal printing processing is performed. Accordingly, the first developing unit 13 develops the latent image on the photosensitive member using the toner stored in the toner container 14 (Step S45).

Meanwhile, at Step S43, when it is judged that the waste toner use instruction is output, an overprinting processing is performed. Accordingly, the second developing unit 15 develops the latent image for overprinting on the photosensitive member using the waste toner stored in the waste toner container 16 (Step S44).

If the development is performed at Step S44 or S45, the transfer unit 17 transfers the developed image on a paper transferred from the paper feed port 9 to a transfer position (Step S46). That is, when the operator selects the overprinting mode, an image for overprinting that is formed using the waste toner is transferred on the printed paper, such as the confidential document or the like, set in the paper feed port 9 by the operator in advance. Meanwhile, when the overprinting mode is not selected, an image that is formed using a raw toner is transferred on a blank paper set in the paper feed port 9.

Next, the fixing unit 18 heats the image transferred on the paper and fixes the image on the paper (Step S47). Subsequently, the paper with the fixed image is discharged from the paper discharge port 10 (Step S48).

As described above according to the printing apparatus of the third embodiment, the image data for overprinting is overprinted on the printed paper, such as the confidential document or the like, by the printing apparatus, such that a printed content cannot be noticed. Therefore, it is possible to dispose the confidential document and so on, without needing a separate shredder.

In addition, since overprinting is performed using the waste toner, the waste toner that is accumulated in the printing apparatus can be decreased, Therefore, the waste toner container can be reduced in size, and thus the printing apparatus can be reduced in size.

The image data for overprinting used in the printing apparatus may use various image data for overprinting in the first embodiment. With this configuration, in view of noticeability of the described content in the confidential document or the like to be overprinted, the same advantages as those in the first embodiment can be obtained.

Like the second embodiment, the image data for overprinting may be a rendering command for overprinting.

### Fourth Embodiment

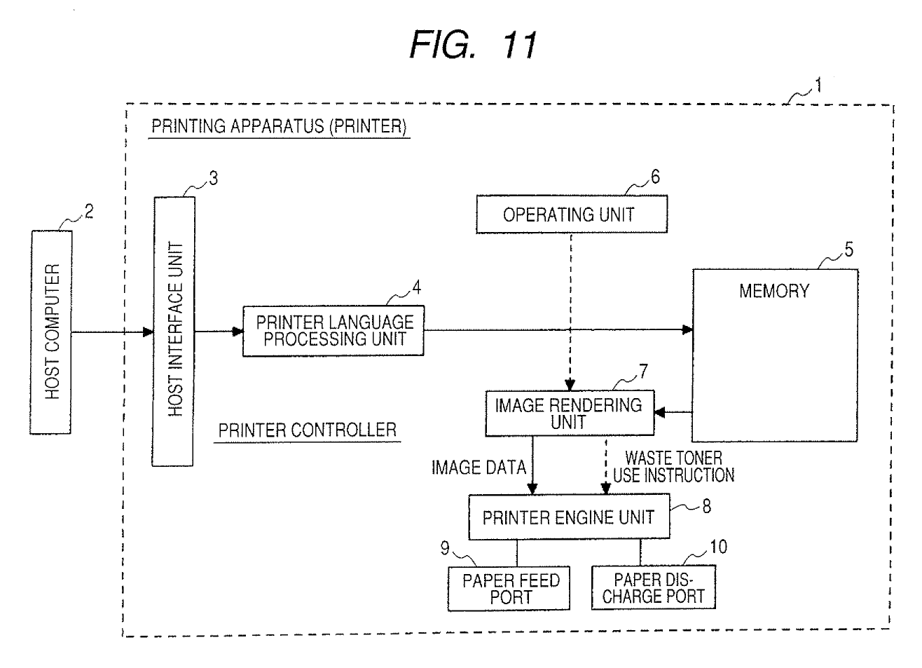

FIG. 11 is a block diagram showing the configuration of a printing apparatus according to a fourth embodiment of the invention.

Here, a printer that reads a printer language such as a page description language or the like, to be transmitted from a host computer 2 connected to the outside, and prints and outputs the read printer language is exemplified as an example of a printing apparatus according to an embodiment of the invention.

In FIG. 11, a printing apparatus 1 primarily includes a host interface unit 3 that receives a printer language to be transmitted from the external host computer 2, a printer language processing unit 4 that analyzes the printer language received by the host interface unit 3, converts the printer language into a rendering command, and writes the rendering command into a memory (data holding unit) 5, an image rendering unit 7 that renders the rendering command in the memory 5, a printer engine unit (image recording unit) 8 that prints and records image data to be transmitted from the image rendering unit 7 on a paper, accompanied by a paper feed port 9, through which a paper to be printed is supplied, and a paper discharge port 10, through which a printed paper is discharged, and an operating unit 6 that allows an operator (user) to perform a required operation. Then, the overall operation of the printing apparatus 1 is controlled by a control unit (not shown).

In the fourth embodiment, a difference from the printing apparatus of FIG. 7 is that the image data for overprinting does not exist in the memory 5.

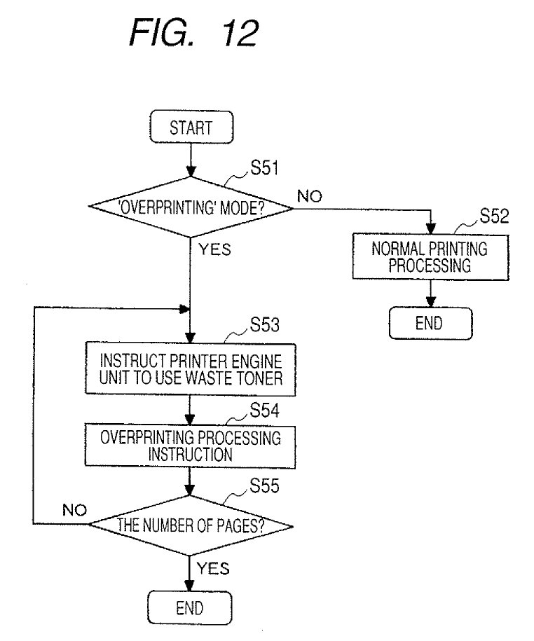

FIG. 12 is a flowchart showing a procedure of a printing operation that is performed in the printing apparatus of FIG. 11.

The printing operation that is performed in the printing apparatus will now be described in detail with reference to FIG. 12.

First, it is judged whether or not the operator selects an overprinting mode in the operating unit 6 (Step S51).

At Step S51, when it is judged that the overprinting mode is not selected, a normal printing processing is performed (Step S52). That is, the image rendering unit 7 acquires the rendering command (not shown) in the memory 5 and performs rendering on the basis of the command. The rendering result is transmitted to the printer engine unit 8 as image data. Then, a paper in the paper feed port 9 is transferred to a printing and recording position in the printer engine unit 8, and the image data is printed and recorded on the paper using a normal toner. Next, the printed and recorded paper is discharged from the paper discharge port 10.

Meanwhile, at Step S51, when it is judged that the overprinting mode is selected, the printer engine unit 8 is instructed to use the waste toner (Step S53).

Next, a printed paper, such as a confidential document or the like, set in the paper feed port 9 by the operator in advance is transferred to the printing and recording position in the printer engine unit 8, and an overprinting processing for overprinting the image data on one entire surface of the printed paper using the waste toner is instructed (Step S54). Then, the overprinted paper is discharged from the paper discharge port 10.

Steps S51 to S54 form an overprinting processing for one page. Then, it is judged whether or not the number of processed pages reaches the number of pages set in the operating unit 6 by the operator (Step S55). That is, the overprinting processing is performed according to the required number of pages.

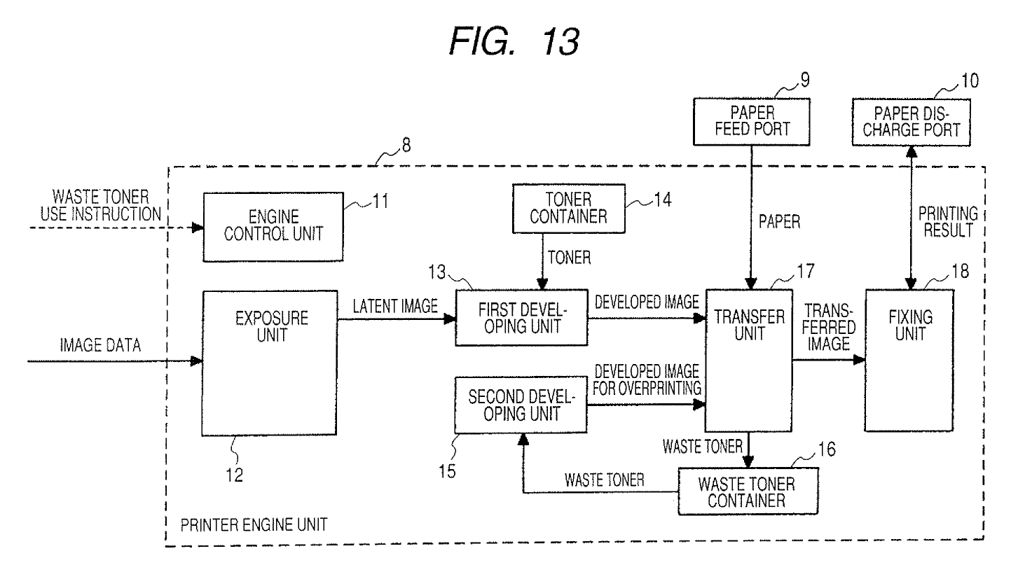

FIG. 13 is a block diagram showing an example of the configuration of a printer engine unit in the printing apparatus of FIG. 11.

In FIG. 13, the printer engine unit 8 primarily includes an engine control unit 11, an exposure unit 12 that receives image data from the outside of the printer engine unit 8, and performs an exposure on a charged photosensitive member (not shown) so as to form a latent image, a first developing unit 13 that develops the latent image using a toner stored in a toner container 14, a second developing unit 15 that develops the latent image using a waste toner stored in a waste toner container (waste toner storage unit) 16, a transfer unit 17 that transfers the developed image on a paper transferred from the paper feed port 9, and a fixing unit 18 that heats the image transferred on the paper so as to fix the image on the paper.

A difference from the printer engine unit of FIG. 9 is that the exposure unit 12 does not supply the latent image for overprinting to the second developing unit 15.

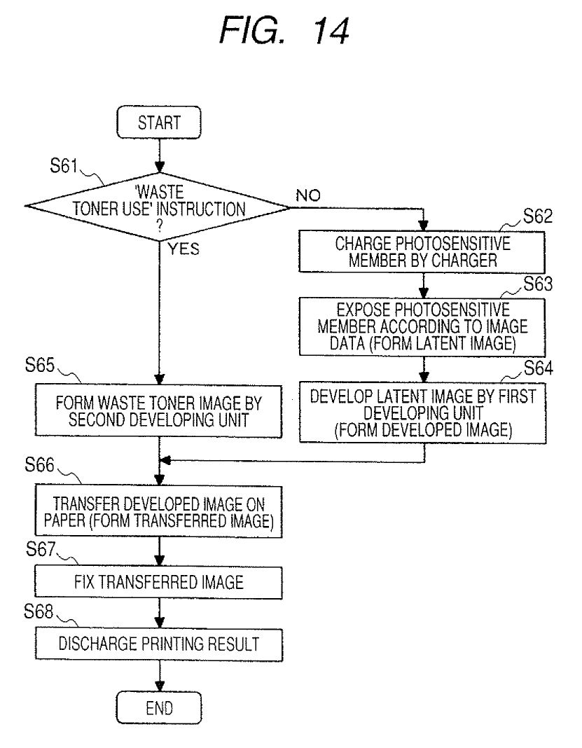

FIG. 14 is a flowchart showing a procedure of a printing operation in the printer engine unit of FIG. 13.

The printing operation in the printer engine unit 8 will be described in detail with reference to FIG. 14.

First, after the printer engine unit 8 starts, the engine control unit 11 judges whether or not a waste toner use instruction is output from the image rendering unit 7 (Step S61).

At Step S61, when it is judged that the waste toner use instruction is output, the normal printing processing is performed, and thus the photosensitive member (not shown) is charged by a charger (not shown) (Step S62). Next, the exposure unit 12 performs the exposure on the charged photosensitive member according to the image data received from the image rendering unit 7 (Step S63). Subsequently, the first developing unit 13 develops the latent image on the photosensitive member using the toner stored in the toner container 14 (Step S64).

Meanwhile, at Step S61, when it is judged that the waste toner use instruction is output, an overprinting processing is performed. Accordingly, the second developing unit 15 forms a waste toner image for overprinting on the photosensitive member using the waste toner stored in the waste toner container 16 (Step S65). That is, since the photosensitive member, not subjected to charging and exposure, has a low electrostatic level, even though the photosensitive member is not subjected to a latent image forming process, the waste toner image is formed on the entire surface of the photosensitive member by applying a developing bias. Then, the waste toner image is used for overprinting.

Next, the transfer unit 17 transfers the developed image on the paper transferred to a transfer position (Step S66). That is, when the operator selects the overprinting mode, the waste toner image for overprinting is transferred on the printed paper, such as the confidential document or the like, set in the paper feed port 9 by the operator in advance using the waste toner. Meanwhile, when the overprinting mode is not selected, an image that is formed using a raw toner is transferred on a blank paper set in the paper feed port 9.

Next, the fixing unit 18 heats the image transferred on the paper and fixes the image on the paper (Step S67). Subsequently, the paper with the fixed image is discharged from the paper discharge port 10 (Step S68).

As described above, according to the printing apparatus of the fourth embodiment, the image data for overprinting is overprinted on the printed paper, such as the confidential document or the like, by the printing apparatus, such that the described content cannot be noticed. Therefore, it is possible to dispose the confidential document and so on, without needing a separate shredder.

In addition, since overprinting is performed using the waste toner, the waste toner that is accumulated in the printing apparatus can be decreased. Therefore, the waste toner container can be reduced in size, and thus the printing apparatus can be reduced in size.

This application is based upon and claims the benefit of priority of Japanese Patent Application No. 2005-201521 filed on Jul. 11, 2005, the contents of which are incorporated herein by reference in its entirety.

When the waste toner is used, the printing apparatus according to the invention is applied to a laser recording type printing apparatus, but may be applied to printing apparatuses of various recording types, such as an ink jet recording type and so on.

What is claimed is:

1. A printing apparatus comprising:
a paper feed port that sets a recording medium, on which an image is printed;
a data holding unit that stores predetermined image data for overprinting;
an operating unit that instructs overprinting on the recording medium; and
an image recording unit that overprints the predetermined image data for overprinting on the recording medium set in the paper feed port by the instruction of the operating unit,
wherein the predetermined image data for overprinting has complexity according to predetermined ununiformity.

2. The printing apparatus according to claim 1, wherein the predetermined image data for overprinting has complexity according to the predetermined uniformity by an image pattern having a plurality of spatial frequency components in a predetermined direction.

3. The printing apparatus according to claim 2, wherein the plurality of spatial frequency components are generated by an arrangement of a random character group.

4. The printing apparatus according to claim 2, wherein the plurality of spatial frequency components are generated by an arrangement of a character group having a plurality of character sizes.

5. The printing apparatus according to claim 2, wherein the plurality of spatial frequency components are generated by an arrangement of a character group having a plurality of character angles.

6. The printing apparatus according to claim 3, wherein the character group has a predetermined character string.

7. The printing apparatus according to claim 2, wherein the plurality of spatial frequency components are generated by a line drawing group obtained by combining line drawings having a plurality of boldnesses.

8. The printing apparatus according to claim 1, further comprising:
a waste toner storage portion,
wherein the image recording unit uses a waste toner of the waste toner storage portion when overprinting on the recording medium.

9. A printing apparatus comprising:
a paper feed port that sets a recording medium, on which an image is printed;
a data holding unit that stores a predetermined rendering command for overprinting;
an image rendering unit that renders the image data for overprinting on the basis of the rendering command for overprinting;
an operating unit that instructs overprinting on the recording medium; and
an image recording unit that overprints the image data for overprinting on the recording medium set in the paper feed port by the instruction of the operating unit,
wherein the image data for overprinting has complexity according to predetermined ununiformity.

10. The printing apparatus according to claim 9, wherein the image data for overprinting rendered on the basis of the rendering command for overprinting has complexity according to the predetermined ununiformity by an image pattern having a plurality of spatial frequency components in a predetermined direction.

11. The printing apparatus according to claim 10, wherein the plurality of spatial frequency components are generated by an arrangement of a random character group.
